(19) United States
(12) Patent Application Publication
(10) Pub. No.: US 2017/0199897 A1
(43) Pub. Date: Jul. 13, 2017

(54) INFERRING QUALITIES OF A PLACE

(71) Applicant: Facebook, Inc., Menlo Park, CA (US)

(72) Inventors: Adriel Samuel Frederick, San Francisco, CA (US); Benjamin Bregman, San Francisco, CA (US); Robert James Sicurelli, III, Manhattan, NY (US); Jan Kalis, New York, NY (US)

(21) Appl. No.: 14/990,669

(22) Filed: Jan. 7, 2016

(51) Int. Cl. G06F 17/30

(52) U.S. Cl. CPC G06F 17/30241; G06F 17/30867; G06F 17/30368; G06F 17/30528

(57) ABSTRACT

The present disclosure is directed toward systems and methods for inferring one or more qualities of a place based on social networking system activity associated that place. The present disclosure is also directed toward systems and methods for providing a multi-step search tool that utilizes the inferred qualities of places within a geographic area to provide a user with a more meaningful search experience.

### CROSS REFERENCE TO RELATED APPLICATIONS

N/A

### BACKGROUND

1. Technical Field

One or more embodiments disclosed herein relate generally to a social networking system. More specifically, one or more embodiments disclosed herein relate to performing searches in association with a social networking system.

2. Background and Relevant Art

Internet users have become accustomed to utilizing various Internet search tools via their mobile devices. For example, users are accustomed to performing an Internet search on a mobile device (e.g., a smart phone, a tablet, a smart wearable, etc.) for good places to eat nearby, interesting things to do in a city they are visiting, and so forth. In order to perform such a search, a user generally enters in a search term and then sifts through the returned search results to find a particular search result.

Existing search tools, however, rarely provide truly relevant search results to an Internet user. For example, existing search tools often present paid search results to a user that are only tangentially related to the user's search query. Similarly, existing search tools generally give no indication to the user of other user's opinions and ratings related to the returned search results. Accordingly, the user typically has no way of knowing whether a list of search results returned from an existing search tool is actually representative of what the user is searching for, and not just thinly veiled paid advertisements.

To illustrate, an Internet user submits a search query to a standard search tool on his mobile phone for “great family restaurants near me.” Generally, the standard search tool will return a list of results that includes paid advertisements from restaurants that may only be within the same city where the user is currently located. Similarly, the standard search tool may return additional results that include restaurants that are commercially ranked (e.g., by professional ranking services) based on criteria that do not match the user's stated intent (e.g., “family restaurants”). Additionally, if the standard search tool returns any results related to family restaurants, those results are likely to be establishments that advertise themselves as good family restaurants rather than restaurants that other users have found to be good for families. As such, the standard search tool typically does not return search results that are of much use to the user.

Furthermore, in order to further refine his search, the user generally must take a trial and error approach to constructing a search query for a standard search tool. For example, after an initial search query fails to result in relevant search results, the user generally adds further search terms to the query in an attempt to more accurately direct the standard search tool. The user may redefine the search query multiple times before the standard search tool returns results in which the user is actually interested. This trial and error approach is often a frustrating and time-wasting effort for the user.

Thus, there are several disadvantages to current methods for performing Internet searches with standard search tools.

### SUMMARY

One or more embodiments described herein provide benefits and/or solve one or more of the foregoing or other problems in the art with systems and methods for providing an Internet search tool via a social networking system. One or more embodiments described herein include systems and methods categorize places within a geographic area based on social networking system activity. For example, systems and methods described herein analyze activity associated with monitored social networking system posts in order to determine whether a particular place can be categorized in various ways. Thus, in response to a search query received from a social networking system user, systems and methods can identify a particular place based on activity submitted by other social networking system users.

Additionally, one or more embodiments described herein include systems and methods for generating a customized search tool. For example, systems and methods described herein generate a customized search tool for a social networking system user based on activity specific to the social networking system user. In one or more embodiments, the generated customized search tool assists the social networking system user to build a search query that is specific to the social networking system user. Thus, the social networking system user does not need to waste time or energy determining the best language to include in a search query that will yield search results that are actually of interest to the social networking system user.

Additional features and advantages of the present application will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above recited and other advantages and features can be obtained, a more particular description of the aspects of one or more embodiments briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments and are not therefore to be considered to be limiting of scope, one or more embodiments will be described and explained with additional specificity and detail through the use of the accompanying drawings in which:

FIG. 1 illustrates a detailed schematic diagram of a search management system in accordance with one or more embodiments;

FIG. 2 illustrates a block diagram of an environment for implementing the search management system of FIG. 1 in accordance with one or more embodiments;

FIGS. 3A-3E illustrate a series of user interfaces in connection with the search management system that show the process by which the search management system infers qualities of a particular place and enables the user of a customized multi-step search tool;

FIG. 4 illustrates a flowchart of a series of acts in a method of inferring qualities of a place via a social networking system in accordance with one or more embodiments;

FIG. 5 illustrates a block diagram of an exemplary computing device in accordance with one or more embodiments;

FIG. 6 is an example network environment of a social networking system in accordance with one or more embodiments; and

FIG. 7 illustrates a social graph in accordance with one or more embodiments.

### DETAILED DESCRIPTION

One or more embodiments described herein provide benefits and/or solve one or more of the foregoing or other problems in the art with systems and methods for performing searches via a social networking system. For example, the search management system of one or more embodiments described herein monitors social networking system posts for activity specific to one or more places within a geographic region. From this activity, the search management system described herein infers qualities and characteristics of the one or more places. Additionally, the search management system of one or more embodiments described herein generates a customized search tool via the social networking system that enables a social networking system user to build a search query that is tailored to the social networking system user.

To illustrate, the search management system monitors user submitted posts related to a particular place. For example, if the particular place is a restaurant, various social networking system users may “check-in” at the restaurant, where each check-in post includes activity related to the user checking in at the restaurant. Each check-in post may include activity about the user checking in (e.g., the user's name), activity about other tagged users (e.g., people the user is with at the restaurant), a comment from the user (e.g., “I love this restaurant! Great pizza!”), a map showing where the restaurant is located, media uploaded by the user in connection with the restaurant (e.g., a digital photograph or video), and “likes” and/or comments from other social networking system users related to the check-in.

Accordingly, the search management system identifies all posts related to the restaurant and analyzes the activity associated with each post in order to infer qualities and characteristics of the restaurant. For example, the search management system performs a textual analysis on any text included in a check-in post or other type of social networking system post (e.g., text added by the user checking in, comments added to the post by other users, etc.). The textual analysis identifies various keywords and sentiments that are indicative of one or more qualities or characteristics of the restaurant. To illustrate, the post may include text such as, “This place has such a romantic ambiance!” From an analysis of this text, the search management system can infer the restaurant is associated with qualities such as “romantic,” “has an ambiance,” “good for dates,” “good for anniversaries,” “not great for little kids,” etc.

Similarly, the search management system performs an image analysis on any digital media included in a social networking system post related to a particular place. For example, the image analysis identifies faces (e.g., via facial recognition), objects (trees, candles, etc.), and so forth. From this image analysis, the search management system can infer further qualities associated with the place. For instance, if the image analysis reveals multiple smiling faces in a digital photograph associated with a check-in post for a restaurant, the search management system may infer that the restaurant is a good place for large groups to meet up, or that the restaurant is not a good place for a quiet romantic date, etc. If the image analysis reveals tables and chairs along with trees and shrubs, the search management system may infer that the restaurant has outdoor seating.

Along related lines, the search management system performs further analysis on other social networking system users who have been tagged in a social networking system post. For example, a social networking system user may tag other social networking system users when he checks in at the restaurant to indicate that those other users are with him at the restaurant. By analyzing activity associated with those other users, the search management system can infer further activity about the restaurant. For instance, if the social networking system user tags a group of other users in the restaurant check-in post that the user has tagged in association with check-ins at various bars and clubs, the search management system will infer that the restaurant is a good place for big groups, parties, celebrations, etc. If the social networking system user tags another user in the restaurant check-in post with whom the user is in a romantic relationship (e.g., the social networking system user has indicated in his profile information that the other user is his girlfriend), the search management system will infer that the restaurant is good for a romantic date, or quiet evening.

Over time, the search management system builds a repository of inferred information about the restaurant, as well as for other places within a geographic area (e.g., a city, a region, etc.). As the information about the places within the geographic area is inferred based on user-submitted social networking system activity, the search management system can respond to user search queries with search results that are truly relevant to the user, and not merely paid advertisements. In one or more embodiments, in order to help the user build directed search queries, the search management system provides a multi-step query tool to the user.

In at least one embodiment, the search management system provides the multi-step query tool based on social networking system activity associated with the user. For example, the search management system can analyze social networking activity associated with a user in order to present a prompt within the first step of the multi-step query tool that is generally directed to a search query the user is likely to compose. For instance, in response to the user initiating the multi-step query tool in the late afternoon, the search management system can analyze social networking activity associated with the user to determine the user works full-time downtown and often checks in at restaurants around 7 pm on weeknights. Accordingly, the search management system can provide the user with a prompt in the first step of the multi-step query tool that asks if the user is searching for a restaurant to have dinner at that night. The search management system further customizes the multi-step query tool at proceeding steps based on the user's query selection in the first step of the multi-step query tool.

As used herein, the term “social networking system” refers to a system that supports and enables on-line communication, input, interaction, content-sharing, and collaboration between users. A user of the social networking system can have one or more “friends” via the social networking system. As used herein, the term “friend” refers to a co-user associated with a user via the social networking system (i.e., a contact or connection).

As mentioned above, the search management system can monitor social networking system activity for posts specific to one or more places within a geographic area. Similarly, the search management system can identify and analyze social networking system activity specific to one or more social networking system users. As used herein, “social networking system activity” refers to an interaction between a social networking system user and the social networking system. For example, the social networking system provides various input controls that allow a user to “check-in” at a particular place, comment on posts submitted by other users, “like” (e.g., indicate agreement with or support for) a post, share an article, etc. Any of these interactions qualify as social networking system activity.

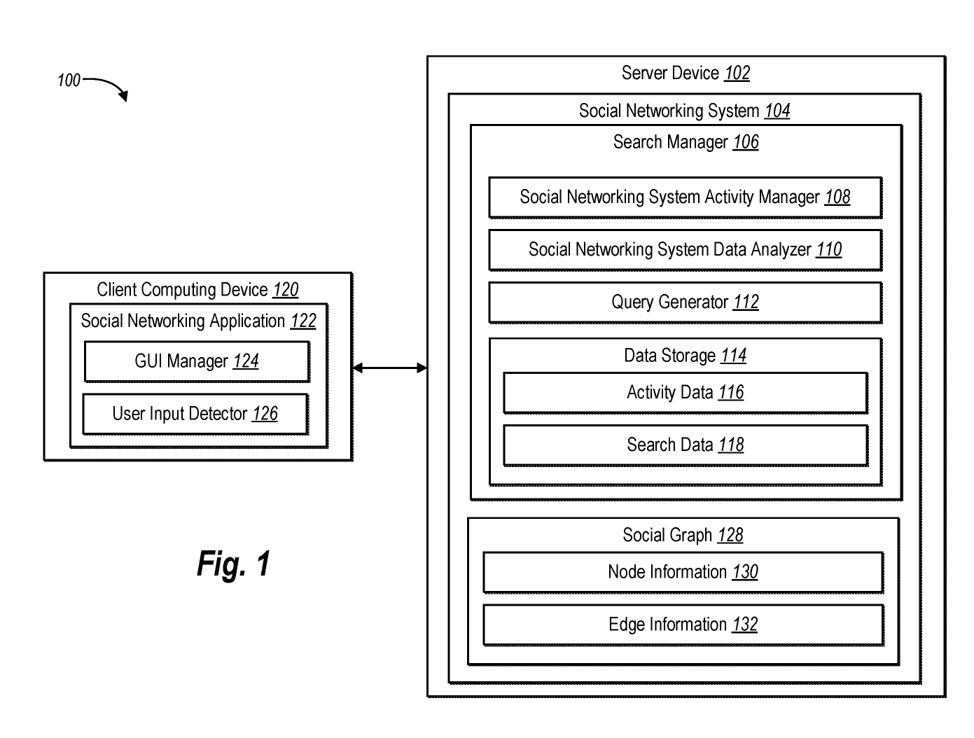

FIG. 1 illustrates a schematic diagram illustrating an example embodiment of a search management system 100 (or simply “system 100”). As shown in FIG. 1, the system 100 may include various components for performing the processes and features described herein. For example, as shown in FIG. 1, the system 100 may include, but is not limited to, one or more server devices 102, a social networking system 104, a search manager 106, and at least one client computing device 120. The search manager 106 can include, but is not limited to, a social networking system activity manager 108, a social networking system data analyzer 110, a query generator 112, and a data storage 114, which includes activity data 116 and search data 118. The social networking system 104 also includes a social graph 128, which includes node information 130 and search data 132. The client computing device 120 includes a social networking application 122, which includes a GUI manager 124 and a user input detector 126.

The social networking system 104, each of the components 108-132 can be implemented using a computing device including at least one processor executing instructions that cause the system 100 to perform the processes described herein. In some embodiments, the components of the social networking system 104 can be implemented by a single server device 102, or across multiple server devices 102. Additionally or alternatively, a combination of one or more server devices and one or more client devices can implement the components of the social networking system 104 and/or the client computing device 120. Furthermore, in one embodiment, the components 102-132 can comprise hardware, such as a special-purpose processing device to perform a certain function. Additionally or alternatively, the components 102-132 can comprise a combination of computer-executable instructions and hardware.

In one or more embodiments, the social networking application 122 can be a native application installed on the client computing device 120. For example, the social networking application 122 may be a mobile application that installs and runs on a mobile device, such as a smart phone, a tablet, etc. Alternatively, the social networking application 122 can be a desktop application, widget, or other form of a native computer program. Alternatively, the social networking application 122 may be a remote application accessed by the client computing device 120. For example, the social networking application 122 may be a web application that is executed within a web browser of the client computing device 120.

As mentioned above, and as shown in FIG. 1, the social networking application 122 includes a graphical user interface (or simply “GUI”) manager 124. The GUI manager 124 provides, manages, and/or controls a graphical user interface (or simply “user interface”) that allows a user to compose, view, and submit social networking system posts, check-ins, etc. Furthermore, the GUI manager 124 provides a user interface that facilitates display of posts, digital media, and/or other content. Likewise, the GUI manager 124 provides a user interface that facilitates the display of a social networking system user's newsfeed or “wall.”

More specifically, the GUI manager 124 can facilitate the display of a user interface (e.g., by way of a display device associated with the client computing device 120). For example, the GUI manager 124 may compose the user interface of a plurality of graphical components, objects, and/or elements that allow a user to compose, send, and receive electronic messages, social networking system posts, etc. More particularly, the GUI manager 124 may direct the client computing device 120 to display a group of graphical components, objects, and/or elements that enable a user to view social networking system posts, digital media, etc.

In addition, the GUI manager 124 directs the client computing device 120 to display one or more graphical objects, controls, applications, or elements that facilitate user input for composing and sending posts and check-ins, and/or viewing digital media. To illustrate, the GUI manager 124 provides a user interface that allows a user to provide user input to the social networking application 122. For example, the GUI manager 124 can provide one or more user interfaces that allow a user to input one or more types of content into a social networking system post, check-in, etc. As used herein, “content” refers to any data or information to be included as part of a social networking system post, check-in, comments, etc. For example, the term “content” will be used herein to generally described text, images, applications, digital media, files, location information, payment information, or any other data that can be included as part of a social networking system post, check-in, message, comment, etc.

The GUI manager 124 also facilitates the input of text or other data to be included in a social networking system post, check-in, message, comment, etc. For example, the GUI manager 124 can provide a user interface that includes a touch display keyboard or any other touch-responsive graphical elements. A user can interact with the touch display keyboard using one or more touch gestures to input text or other types of input to be included in a social networking system post, check-in, or comment. In addition to text, the user interface including the touch display keyboard can facilitate the input of various other characters, symbols, icons, or other information.

Furthermore, the GUI manager 124 provides and transitions between two or more graphical user interfaces. For example, in one embodiment, the GUI manager 124 provides a newsfeed to a social networking system user containing one or more social networking system posts from co-users associated with the user via the social networking system. Similarly, in response to a detected input from the user, the GUI manager 124 can transition to a second graphical user interface that includes an enlarged or expanded view of a selected posts or check-in.

As further illustrated in FIG. 1, the social networking application 122 can include a user input detector 126. In one or more embodiments, the user input detector 126 can detect, receive, and/or facilitate user input in any suitable manner. In some examples, the user input detector 126 can detect one or more user interactions with respect to the user interface. As referred to herein, a “user interaction” means a single interaction, or combination of interactions, received from a user by way of one or more input devices.

For example, the user input detector 126 detects a user interaction from a keyboard, mouse, touch pad, touch screen, and/or any other input device. In the event the client computing device 120 includes a touch screen, the user input detector 126 can detect one or more touch gestures (e.g., swipe gestures, tap gestures, pinch gestures, or reverse pinch gestures) from a user that forms a user interaction. In some examples, a user can provide the touch gestures in relation to and/or directed at one or more graphical objects or graphical elements of a user interface.

The user input detector 126 may additionally, or alternatively, receive data representative of a user interaction. For example, the user input detector 126 may receive one or more user configurable parameters from a user, one or more user commands from the user, and/or any other suitable user input. The user input detector 126 may receive input data from one or more components of the social networking system 104, or from one or more remote locations.

The social networking application 122 performs one or more functions in response to the user input detector 126 detecting user input and/or receiving other data. Generally, a user can control, navigate within, and otherwise use the social networking application 122 by providing one or more user inputs that the user input detector 126 can detect. For example, in response to the user input detector 126 detecting user input, one or more components of the social networking application 120 allow a user to select or input information for inclusion in a social networking system post or check-in. Additionally, in response to the user input detector 126 detecting user input, one or more components of the social networking application 122 allow a user to navigate through one or more user interfaces to review a newsfeed, inspect a check-in, view digital media, etc.

As illustrated in FIG. 1, the search management system 100 includes the social networking system 104 hosted by a server device 102. The social networking system 104 provides social networking system posts (whether text or otherwise) to a graphical user interface (e.g., a profile, a newsfeed, or “wall”) of one or more users of the social networking system 104. For example, one or more embodiments may present a user with a social networking system newsfeed. In one or more embodiments, the user may scroll through the social networking system newsfeed in order to view recent social networking system posts submitted by the one or more co-users associated with the user via the social networking system 104. In one embodiment, the social networking system 104 may organize the social networking system posts geographically, by interest groups, according to a relationship coefficient between the user and the co-user, etc. Additionally, in one or more embodiments, the user may download content from the newsfeed and the social networking system posts displayed therein.

Additionally, in one embodiment, the social networking system 104 transmits social networking posts, check-ins, etc. between users. For example, in response to a user submitting a social networking system post to the social networking system 104, the social networking system 104 updates the social networking system newsfeeds of the co-users who are “friends” with the user to include the submitted social networking system post. Accordingly, over time, the social networking system 104 fills the newsfeed of a particular social networking system user with the posts, check-ins, etc. submitted by the user's friends.

As mentioned above, and as illustrated in FIG. 1, the social networking system 104 further includes the search manager 106. In one or more embodiments, and as will be discussed in further detail below, the search manager 106 monitors and analyzes social networking system activity in order to infer qualities and characteristics of various places within a geographic region. The search manager 106 includes the social networking system activity manager 108, the social networking system data analyzer 110 and the query generator 112.

In one or more embodiments, the social networking system activity manager 108 communicates with the social networking system 104 to receive various types of information. For example, the social networking system activity manager 108 communicates with the social networking system 104 to receive information related to actions performed by social networking system users, as well as information related to the social networking system users. To illustrate, the social networking system activity manager 108 receives information related to the social networking system activities engaged in by one or more social networking system users. For instance, a social networking user may click links, submit posts, check-in at places, “like” posts, add comments, view digital media, etc. Accordingly, the social networking system activity manager 108 receives, monitors, and tracks information related to any and all social networking system activities performed by a social networking system user.

In one or more embodiments, the social networking system activity manager 108 identifies the content of posts, check-ins, electronic messages, comments, etc. as well as any structured data associated with a post, check-in, comment, etc. As used herein, “structured data” includes any data that is structured into specific groups, fields, or categories and/or associated with particular aspects of a post or a user. Structured data includes metadata associated with node and edge information related to a social networking system post, information related to the post author, information related to a particular item featured in the post, and interaction information (e.g., shares, comments, likes) related to the post within the social networking system 104. To illustrate, structured data for a social networking system post may include the post author's name, the content of the post, the post author's location, information related to a group or newsfeed where the post author submitted the post, or any other specific types of information/data associated with the post. The structured data may also include various media content such as digital video, images, audio, etc. Using this structured data, the social networking system can facilitate the insertion of “rich” objects within a newsfeed or elsewhere, such rich objects providing more information and/or content than typical textual messages.

As mentioned above, the social networking system activity manager 108 can receive information related to a social networking system user including demographic information associated with the user. In one or more embodiments, a user's demographic information can include, but is not limited to, the user's gender, age, education, location, hometown, birthday, employment, salary, family and romantic relationships, and so forth. Additionally, the user's demographic information can be related to the user's personal interests (e.g., favorite books, movies, restaurants, etc.). The social networking system activity manager 108 identifies this information through an analysis of the user's social networking system profile, account information, or via other social networking system activities in which the user engages.

As mentioned above, and as illustrated in FIG. 1, the search manager 106 also includes a social networking system data analyzer 110. As discussed above, the social networking system activity manager 108 monitors social networking system activity and identifies posts and check-ins specific to particular places within a geographic region. Accordingly, in one or more embodiments, the social networking system data analyzer 110 monitors all social networking system activity within a specific geographic region (e.g., a city, a neighborhood, a region, etc.) to identify activity specific to a particular place. In one or more embodiments, the social networking system activity manager 108 monitors the social networking system activity for activity (e.g., posts, check-in posts, etc.) that mention the particular place by name (e.g., the name of a restaurant, the name of a landmark, etc.). In other embodiments, the social networking system activity manager 108 monitors structured data associated with the social networking system activity for location information associated with the social networking system activity (e.g., a GPS location collected from a mobile phone when a user checks in at a particular place using the mobile phone).

As the social networking system activity manager 108 monitors social networking system activity that is specific to a particular place, the social networking system data analyzer 110 analyzes the identified social networking system activity in order to infer one or more qualities or characteristics of the particular place. For example, if the social networking system activity manager 108 identifies a check-in post that is specific to a certain restaurant in a particular city, the social networking system data analyzer 110 will analyze all information related to that identified check-in post in order to infer qualities or characteristics of that restaurant. To illustrate, the check-in post may include the name of the restaurant, various additional tagged “friends,” a comment from the user checking in (e.g., “This place has awesome food and tons of seating! I've never had to wait too long for a table.”), a digital photograph of the user and his group at an outdoor table, additional comments from other users (e.g., “That place has such great pizza,” “It's perfect for lunch, but it gets crowded for dinner,” etc.), and so forth. In one or more embodiments, the social networking system data analyzer 110 analyzes all of this information to infer qualities or characteristics of the restaurant.

For example, the social networking system data analyzer 110 begins analysis of identified social networking system activity (e.g., a check-in post, a standard post, a comment, etc.) by performing textual analysis in connection with the identified social networking system activity. In one or more embodiments, textual analysis includes parsing text associated with the social networking system activity, and applying rules, grammars, databases, neural models, and so forth to the parsed text. In this manner, the social networking system data analyzer 110 identifies keywords, sentiments, meanings, and other information from the analyzed text.

The social networking system data analyzer 110 continues analysis of the identified social networking system activity by performing media analysis in connection with the identified social networking system activity. As mentioned above, various types of social networking system activity (e.g., a standard post, a check-in post) can include a digital photograph or digital video. Accordingly, in one or more embodiments, the social networking system data analyzer 110 performs a media analysis on any media associated with the identified social networking system activity. To perform media analysis, the social networking system manager 108 can apply various algorithms to digital media in order to identify objects (e.g., trees, buildings, people, animals, etc.), colors, light sources (e.g., natural, artificial), and so forth. In at least one embodiment, the social networking system data analyzer 110 can also utilize third party software in analyzing digital media.

Additionally, the social networking system data analyzer 110 analyzes the identified social networking system activity by performing facial recognition in connection with the identified social networking system activity. As mentioned above, the social networking system data analyzer 110 can identify people within digital media. Accordingly, in response to identifying a person in a digital photograph or video, the social networking system data analyzer 110 performs facial recognition in connection with the identified person in order to determine the person's identity and a mood associated with the person's expression. For example, the social networking system data analyzer 110 applies one or more of algorithms, rules, procedures, etc. to the digital media to attempt to match the identified person's face to that of an existing social networking system user. In at least one embodiment, the social networking system data analyzer 110 matches an identified person's face to an existing social networking system user by comparing the person's face from the digital media associated with the social networking activity to an existing image stored by the social networking system 104.

Furthermore, the social networking system data analyzer 110 utilizes additional facial recognition functionality to identify a mood of a person identified within digital media associated with social networking system activity. For example, in one or more embodiments, the social networking system data analyzer 110 utilizes algorithms, databases, rules, etc. to determine whether an identified face in a digital photograph or digital video is happy, sad, angry, excited, and so forth. In at least one embodiment, the social networking system data analyzer 110 stores any identified information related to the analysis of digital media associated with the identified social networking system activity for later use.

Additionally, the social networking system data analyzer 110 performs an analysis of any additional social networking system information associated with the identified social networking system activity. For example, a check-in post may include additional tagged users, a GPS location, comments from other users, and so forth. In one or more embodiments, the social networking system data analyzer 110 identifies a relationship coefficient between the poster of the check-in post and additional social networking system users who are tagged in the post, commented on the post, identified via facial recognition in connection with digital media associated with the post, checking in at nearby locations, etc.

Once the social networking system data analyzer 110 has utilized text analysis, image analysis, facial recognition analysis, social networking system activity analysis, and so forth in connection with an identified social networking system activity associated with a particular place (e.g., a check-in post at a restaurant), the social networking system data analyzer 110 infers various qualities or characteristics of the particular place based on the attributes that result from these various analyses. In one or more embodiments, the social networking system data analyzer 110 infers the various qualities or characteristics of the particular place by applying sets of rules, a neural network model, and/or other types of machine learning. Thus, in at least one embodiment, the social networking system data analyzer 110 can “learn” over time to better infer qualities and characteristics of a place based on social networking system activities associated with that place.

For example, from the keywords, sentiments, phrases, etc. identified in connection with the textual analysis, the social networking system data analyzer 110 can infer that a restaurant serves great local food (e.g., by analyzing text including “The food here isn't fancy, but it sure tastes great!” “Come here for the best seafood in a city known for its seafood!” and so forth). Similarly, from the objects identified in connection with the image analysis of media associated with a check-in post, the social networking system data analyzer 110 can infer that the restaurant has comfortable outdoor seating (e.g., by identifying tables and benches with cushions outside a building with lots of shade trees and awnings). Further, from facial recognition performed in connection with the media associated with the check-in post, the social networking system data analyzer 110 can infer that the restaurant is a great date spot (e.g., by determining that a woman in a digital photograph in a check-in post is the poster's girlfriend and that she looks happy and relaxed). From social networking system activity information associated with check-in, the social networking system data analyzer 110 can also infer that the restaurant is popular among a particular demographic (e.g., based on all the tagged social networking users associated with the check-in being the same age according to their social networking system user profiles).

In addition to the attributes resulting from the various analyses performed on a single check-in post, or other social networking system activity, the social networking system data analyzer 110 also takes existing inference data into account when inferring qualities or characteristics of a particular place. For example, if a particular place is associated with a high number or overall percentage of check-ins, the social networking system data analyzer 110 can infer that the particular place is very popular and/or a tourist location. Furthermore, if the particular place is a restaurant for which the majority of check-ins are only in the evening, the social networking system data analyzer 110 can infer that the restaurant is not a good place to have lunch. Additionally, if the bulk of check-ins at a particular place are from users who are locals rather than tourists, the social networking system data analyzer 110 can infer that the particular place is “off the beaten path,” etc.

Once the social networking system data analyzer 110 has inferred various qualities or characteristics of a place based on the analysis of social networking system activity associated with that place, the social networking system data analyzer 110 builds a repository of the inferred qualities and characteristics associated with that place. For example, the social networking system data analyzer 110 can build the repository of inferred qualities as a table that includes each inferred quality or characteristic and the analysis upon which the inference is based. In additional or alternative embodiments, the social networking system data analyzer 110 builds the repository in the style of a trained model. In that case, the inferred qualities associated with a particular place can evolve over time. For example, the social networking system data analyzer 110 may initially infer that a particular restaurant is “quiet,” but after a short period of time, the particular restaurant may gather a large percentage of check-ins. In response to the increase in the number of check-ins associated with the particular restaurant, the social networking system data analyzer 110 may update the inferred quality “quiet,” to “up-and-coming,” etc.

In some embodiments, the social networking system data analyzer 110 may further include a weight associated with a particular inferred quality or characteristic within the repository. For example, the social networking system data analyzer 110 may weight a quality or characteristic inferred based on textual analysis heavier than a quality or characteristic inferred based on image analysis. In another example, the social networking system data analyzer 110 may weight an inferred quality based on the amount of social networking system activity that lead to the inference of that quality. For example, if a high number or percentage of check-ins indicate a restaurant is great for date, the social networking system data analyzer 110 may give a heavier weight to an inferred “romantic” quality. Similarly, the social networking system data analyzer 110 may weight a quality inferred from a check-in post based on how frequently the poster of the check-in post checks in at other places.

In one or more embodiments, the social networking system data analyzer 110 clusters repositories for particular places based on geographic proximities. For example, a cluster may include a node for a particular neighborhood that is connected to other nodes dedicated to places within that neighborhood for which the social networking system data analyzer 110 has inferred one or more qualities. Thus, repositories for places that are within the same geographic area (e.g., neighborhood, city, region, etc.) are clustered together.

As mentioned above, and as illustrated in FIG. 1, the search manager 106 further includes a query generator 112. As described above, once the social networking system data analyzer 110 builds clusters of repositories of inferred qualities and characteristics for places within a geographic area, the search manager 106 provides a multi-step query tool via the social networking system 104 for social networking system users to perform tailored searches. In one or more embodiments, the query generator 112 generates the multi-step search tool for a social networking system user based on social networking system data associated with that user. In at least one embodiment, the multi-step search tool includes lists of selectable options at each step of the search tool. Each subsequent step of the search tool is customized based on the user's social networking system data as well as on the user's selection within the previous step(s) of the multi-step search tool.

For example, the query generator 112 begins the process of generating the multi-step search tool for a social networking system user by performing an analysis of social networking system data associated with that user. To illustrate, the query generator 112 analyzes the user's previous check-ins, posts, comments, GPS data, and other profile information to determine where the user lives, where the user works, what the user typically does after work and on the weekends, the user's activity level, the user's interests, and so forth. The query generator 112 also identifies current information associated with the user (e.g., the user's current location, the current time, etc.). Thus, in response to the user requesting the multi-step search tool, the query generator 112 can utilize the user's analyzed social networking system data and the user's current information to determine the contents of the first step of the multi-step search tool. For example, in response to a user's request for the multi-step search tool, the query generator 112 may provide a prompt for the user to select a cuisine type in a particular neighborhood after a determination that it is the late afternoon, that the user works near the particular neighborhood, and that the user frequently checks in at restaurants on weeknights after work.

In response to the user's selection of a particular cuisine type in the particular neighborhood, the query generator 112 provides the next step of the multi-step search tool based on the user's selection, as well as on the user's social networking system data. For example, if the user selects “Mexican” from the list of cuisine types, the query generator 112 utilizes the user's social networking system data to determine that other restaurants the user has checked in at in the past tend to have qualities such as “quiet,” “gourmet,” “moderately priced,” “good for takeout.” Thus, in the next step of the multi-step search tool, the query generator 112 can provide a list of selectable options that will allow the user to further narrow down his search for Mexican food restaurants. For instance the list may include selectable options such as: “Someplace quick,” “Someplace nice but not spendy,” “Most authentic Mexican food around.”

In one or more embodiments, the query generator 112 can generate as many steps in the multi-step search tool as are needed to adequately narrow a user's search. The result of the user's response to the one or more steps of the multi-step search tool is a search query that the search manager 106 applies to repositories built by the social networking system data analyzer 110. For example, in response to the user's selections of “Mexican,” and “Someplace quick,” in the example above, the query generator 112 will query the cluster of repositories for places in or near the neighborhood near the user for restaurants that have inferred qualities such as, “Mexican food,” “fast service,” “no waits,” “tasty and cheap,” and so forth. The query generator 112 can then present the results of this query to the user. In at least one embodiment, the list of results presented to the user can include links to directions to each restaurant, to reservations for each restaurant, to user ratings for each restaurant, to menus for each restaurant, etc.

Furthermore, as mentioned above, and as illustrated in FIG. 1, the search manager 106 also includes a data storage 114. As shown, the data storage 114 includes activity data 116 and search data 118. In one or more embodiments, the activity data 116 can include data representative of social networking system activity information, such as described herein. Similarly, in one or more embodiments, the search data 118 can include data representative of search information (e.g., clusters of repositories, search queries, etc.), such as described herein.

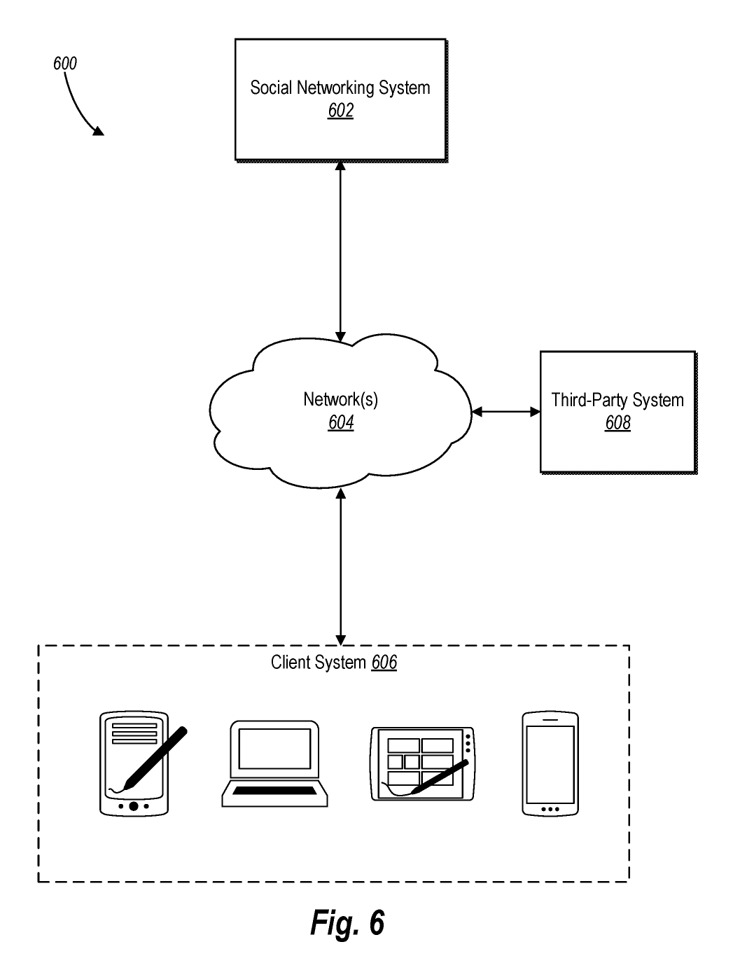

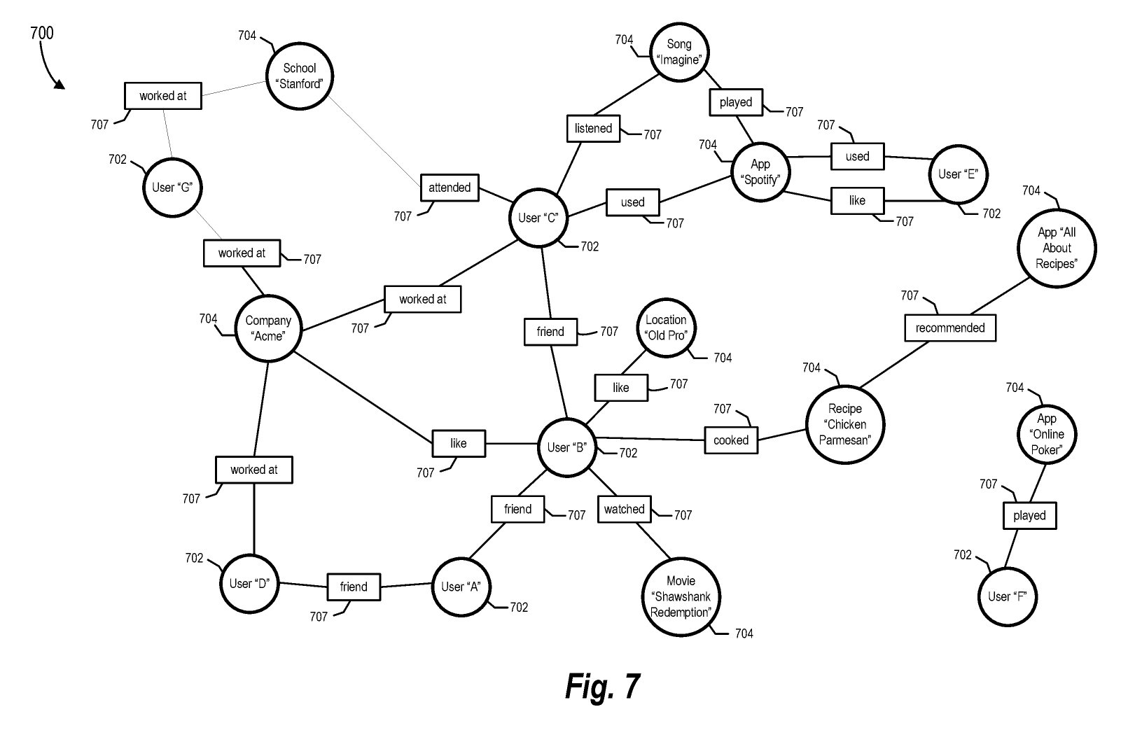

Additionally, in one or more embodiments and as illustrated in FIG. 1, the social networking system 104 may include a social graph 128 for representing and analyzing a plurality of users, actions, and concepts. Node information 130 of the social graph 128 can store node information comprising, for example, nodes for users and nodes for repositories. Edge information 132 of the social graph 128 can store edge information comprising relationships between nodes and/or actions occurring within the social networking system 104. Further detail regarding the social networking system 104, social graphs, edges, and nodes is presented below with respect to FIGS. 6 and 7.

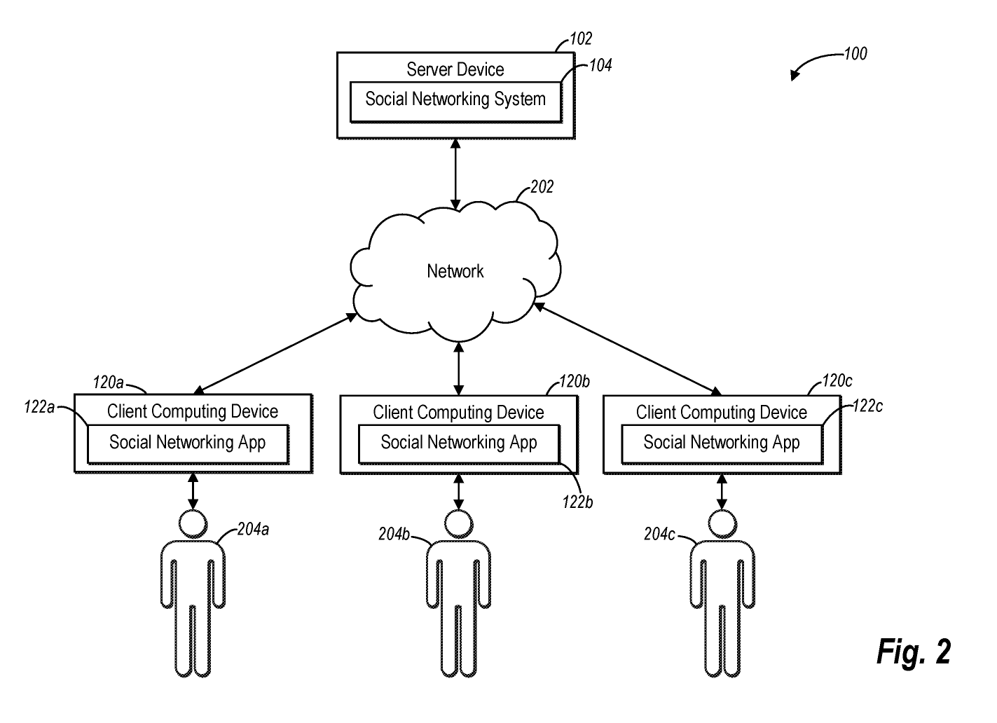

FIG. 2 illustrates a schematic diagram of an example environment and implementation of the search management system 100. As illustrated in FIG. 2, the search management system 100 can be implemented across client computing devices 120a, 120b, and 120c each running the social networking applications 122a, 122b, and 122c respectively, as well as the server device 102 housing the social networking system 104. Also as illustrated in FIG. 2, the users 204a, 204b, 204c may interact with the client computing devices 120a, 120b, and 120c respectively in order to access content and/or services on the social networking system 104. Each of the client computing devices 120a, 120b, and 120c may access the social networking system 104 via the social networking applications 122a, 122b, and 122c, as described above.

The client computing devices 120a, 120b, and 120c and the social networking system 104 can communicate via the network 202, which may include one or more networks and may use one or more communication platforms or technologies suitable for transmitting data and/or communication signals. In one or more embodiments, the network 202 may include the Internet or World Wide Web. The network 202, however, can include various other types of networks that use various communication technologies and protocols, such as a corporate intranet, a virtual private network (VPN), a local area network (LAN), a wireless local network (WLAN), a cellular network, a wide area network (WAN), a metropolitan area network (MAN), or a combination of two or more such networks. Although FIG. 2 illustrates a particular arrangement of client computing devices 120a, 120b, and 120c, the social networking system 104, the server device 102, and the network 202, various additional arrangements are possible. For example, the client computing devices 120a, 120b, and 120c may directly communicate with the social networking system 104, bypassing the network 202. Additional details relating to the network 202 are explained below with reference to FIG. 6.

As illustrated in FIG. 2, the users 204a, 204b, and 204c can use the search management system 100 to engage in social networking system activity related to particular places and to build customized queries for information on particular places within a geographic area. The users 204a, 204b, and 204c may be individuals (i.e., human users), businesses, groups, or other entities. Although FIG. 2 illustrates three users 204a, 204b, and 204c, it is understood that the search management system 100 can allow a plurality of additional users to exchange communications and transactions via a corresponding additional client computing devices.

With reference to the search management system 100 described herein, any of the users 204a, 204b, or 204c can be a sender/creator of a post or electronic content to be shared via the social networking system 104, and any of the users 204a, 204b, or 204c can be a recipient of a post or other electronic content shared via the social networking system 104. In certain embodiments, the social networking system 104 can ensure the users 204a, 204b, 204c are “friends” via the social networking system 104 before they can send and receive posts or electronic messages among each other. Further, the social networking system 104 can share content from users 204a, 204b, 204c in accordance with privacy settings set by each of users 204a, 204b, 204c. In additional or alternative embodiments, the social networking system 104 may simply ensure that users sending and receiving communications merely be active users of the social networking system 104.

The client computing devices 120a, 120b, and 120c may include various types of computing devices. For example, the client computing devices 120a, 120b, and 120c can include a mobile device such as a mobile telephone, a smartphone, a personal digital assistant, a table, a laptop, a smart wearable, or a non-mobile device such as a desktop, a server, and/or another type of computing device. Further, the client computing devices 120a, 120b, and 120c may run dedicated social networking applications (e.g., such as the social networking applications 122a, 122b, and 122c, as described above in relation to FIG. 1) associated with the social networking system 104 to access social networking content (e.g., posts, check-ins, messages, digital media, etc.) associated with the search management system 100. Additional details with respect to the client computing devices 120a, 120b, and 120c and the social networking system 104 are discussed below with respect to FIGS. 5 and 6.

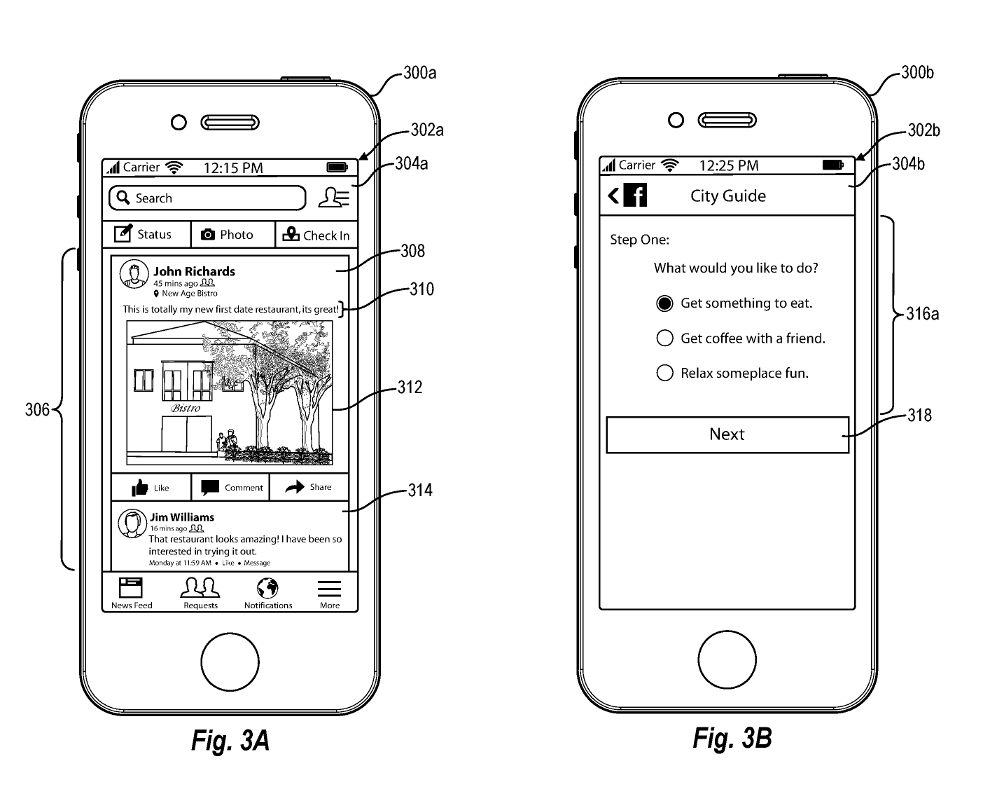

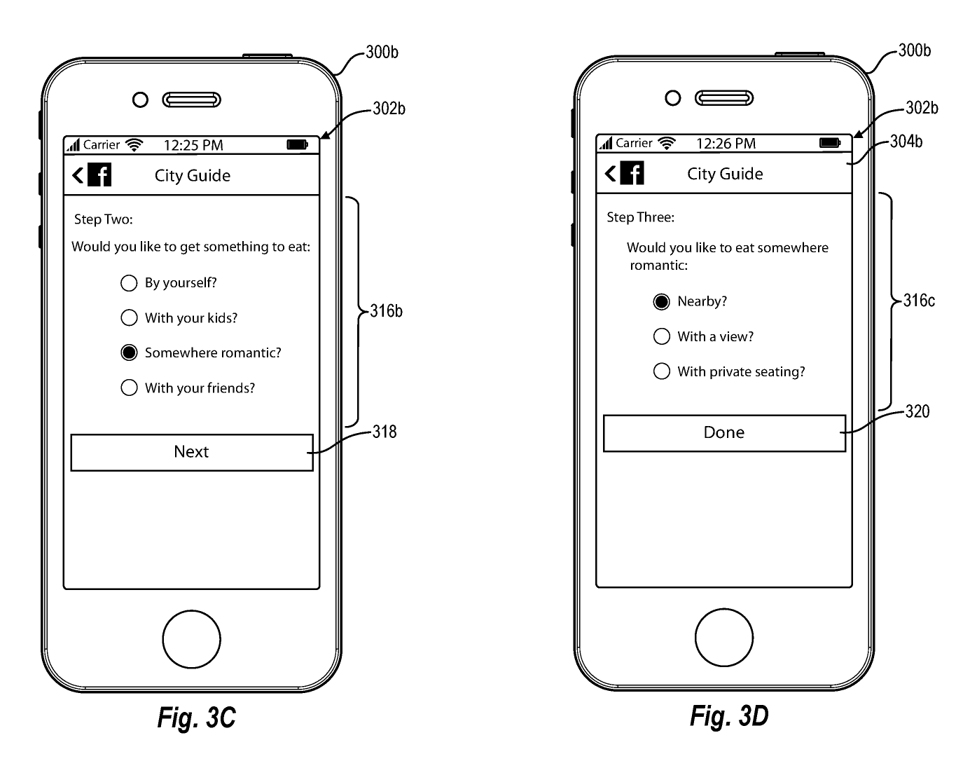

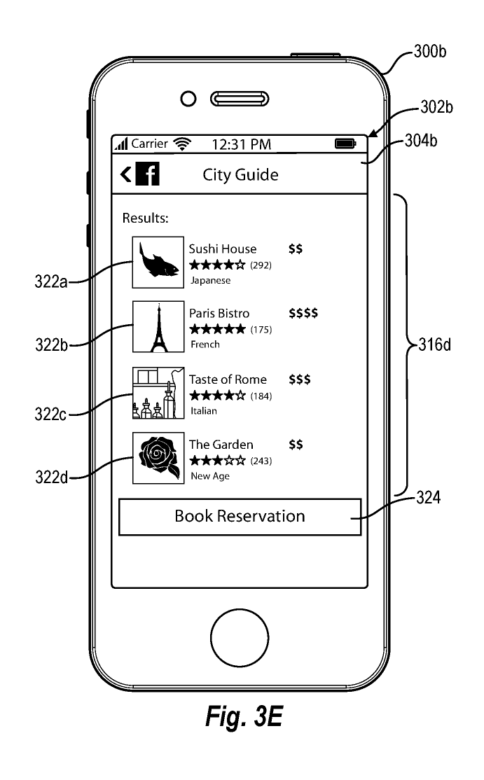

As will be described in more detail below, the components of the search management system 100 as described with regard to FIGS. 1 and 2 can provide, along and/or in combination with other components, one or more graphical user interfaces (“GUIs”). In particular, the components can allow a user to interact with a collection of display elements for a variety of purposes. Specifically, FIGS. 3A-3E and the description that follows illustrate various example embodiments of the GUIs and features that are in accordance with general principles as described above.

For example, FIGS. 3A-3E illustrate various views of GUIs provided at one of the client computing devices 120a, 120b, and 120c by way of the social networking application 122a, 122b, and 122c, respectively. As mentioned above, in some embodiments, a client computing device (i.e., the client computing device 120a, 120b, or 120c) can implement and/or provide features from the search management system 100. For example, FIG. 3A illustrates a client computing device 300a of a social networking system user (e.g., one of the users 204a, 204b, or 204c) that may implement one or more of the components or features of the search manager 106. As shown, the client computing device 300a is a handheld device, such as a mobile phone device (e.g., a smartphone). In additional or alternative examples, however, any other suitable computing device, such as, but not limited to, a tablet device, larger wireless device, laptop or desktop computer, a personal digital assistant device, and/or any other suitable computing device can perform one or more of the processes and/or operations described herein.

As illustrated in FIG. 3A, the client computing device 300a includes a touch screen display 302a that can display a user interface and by way of which user input may be received and/or detected. In particular, the client computing device 300a can be a touch screen device. In one or more embodiments, a touch screen device may be the client computing device 120a, 120b, or 120c with at least one surface upon which a user may perform touch gestures (e.g., a laptop, a tablet computer, a personal digital assistant, a media player, a mobile phone, etc.). Additionally or alternatively, the client computing device 300a may include any other suitable input device, such as a touch pad or those described below in reference to FIG. 5.

In FIG. 3A, the touch screen display 302a of the client computing device 300a displays a social networking system GUI 304a provided by the GUI manager 124 of the social networking application 122 installed thereon. In one or more embodiments, the GUI manager 124 provides the social networking system GUI 304a in order to provide a display of a newsfeed 306 of the user of the client computing device 300a. As shown, the newsfeed 306 includes various types of social networking system activity of users associated with the user of the client computing device 300a (e.g., friends of the user of the client computing device 300a), including the check-in post 308.

As described above, the newsfeed 306 can include posts, check-ins, and so forth. As shown in FIG. 3A, the check-in post 308 includes information identifying the social networking friend who created the post (e.g., “John Richards), information identifying a particular place where the friend checked in (e.g., “New Age Bistro”), post text 310 entered by the friend (e.g., “This is totally my new first date restaurant, its great!”), a post media 312 showing the check-in location, and a post comment 314 from another social networking user (e.g., “Jim Williams”) related to the check-in (e.g., “That restaurant looks amazing! I have been so interested in trying it out.”).

As described above, upon submission of the check-in post 308 to the social networking system 104, the search manager 106 analyzes information associated with the check-in post 308 to infer qualities or characteristics of a place related to the check-in post 308 (e.g., “New Age Bistro”). For example, the search manager 106 can perform a textual analysis of the text associated with the check-in post 308 to infer that the “New Age Bistro” has the following qualities or characteristics: “good for dates,” “romantic,” “good ambiance,” “great food,” “interesting setting,” and so forth. Similarly, the search manager 106 can perform an image analysis in connection with the post media 312 to determine that the “New Age Bistro” has shady trees and outdoor seating. The search manager 106 can also perform facial recognition in an attempt to identify the people depicted in the post media 312.

The search manager 106 can also perform an analysis of social networking data associated with the check-in post 308. For example, the search manager 106 may determine that the poster (e.g., “John Richards”) frequently submits check-in posts to the social networking system 104. Accordingly, the search manager 106 may give extra weight to the qualities inferred with regard to the “New Age Bistro” based on the check-in post 308.

Once the search manager 106 infers one or more qualities and/or characteristics of the “New Age Bistro,” the search manager 106 builds or adds to an existing repository associated with the “New Age Bistro.” Later, the search manager 106 can utilize this and other repositories to provide a multi-step search tool. For example, as shown in FIG. 3B and in response to a user's request for the multi-step search tool, the search manager 106 provides the first step 316a of the multi-step search tool to the user of the client computing device 300b via a query tool GUI 304b on the touch screen display 302 of the client computing device 300b. As described above, the search manager 106 determines the contents of the first step 316a of the multi-step search tool based on current information (e.g., the current date and time, the user's current location), and other social networking system information related to the user (e.g., where the user works, other places the user has checked in, etc.). Accordingly, based on the current information and other information related to the user of the client computing device 300b, the search manager 106 can determine that the user of the client computing device 300b is likely looking to “get something to eat,” “get coffee with a friend,” or “relax someplace fun,” as illustrated by the selectable options listed in the first step 316a of the multi-step search tool. In additional or alternative embodiments, the search manager 106 may present the selectable options listed within the first step 316a based on default selections.

In response to the user selecting “get something to eat,” and tapping the next button 318, the search manager 106 can provide further steps of the multi-step search tool to meaningfully narrow the user's search query. For example, as shown in FIG. 3C, the search manager 106 provides the selectable options listed in the second step 316 of the multi-step search tool to help further narrow down the user's search for “something to eat.” In one embodiment, the search manager 106 provides the selectable options listed in the second step 316 in response to an analysis of qualities and/or characteristics of other restaurants where the user has checked-in. Alternatively or additionally, the search manager 106 provides the selectable options listed in the second step 316 in response to an analysis of qualities and/or characteristics of restaurants in the same geographic area where the user is currently located. For example, the selectable options listed in the second step 316 may be related to inferred qualities of restaurants nearby that are associated with high numbers of check-ins.

In response to the user selecting an option (e.g., “Somewhere romantic”) from the second step 316b of the multi-step tool presented on the touch screen display 302b of the client computing device 300b and tapping the next button 318, as shown in FIG. 3C, the search manager 106 provides a third step 316c of the multi-step tool, as shown in FIG. 3D. As with the second step 316b, as shown in FIG. 3C, the search manager 106 provides the options listed in the third step 316c, as shown in FIG. 3D, based on the user's selection in the previous step, as well as on qualities and characteristics of restaurants where the user has previously checked in and/or restaurants within the same geographic area where the user is located.

In response to the user selecting an option (e.g., “Nearby”) from the third step 316c and tapping the done button 320, as shown in FIG. 3D, the search manager 106 can generate and execute a search query based on the user's selections within the multi-step search tool. As described above, the search manager 106 can extract qualities and characteristics from the user's selections within the steps of the multi-step search tool and search from those qualities and characteristics within a cluster of repositories for places within the corresponding geographic area. For example, the search manager 106 can search a cluster of repositories for restaurants near the user's current location that are “romantic.”

In one or more embodiments, the search manager 106 provides a list of search results 322a-322d in the last step 316d of the multi-step search tool, as shown in FIG. 3E. In at least one embodiment, each search result 322a, 322b, 322c, and 322d can include information related to each result (e.g., a rating, an average price point, etc.). Furthermore, in at least one embodiment, in response to the user selecting one of the search results 322a-322d and tapping the book reservation button 324, the search manager 106 can further facilitate booking a reservation in connection with the selected search result.

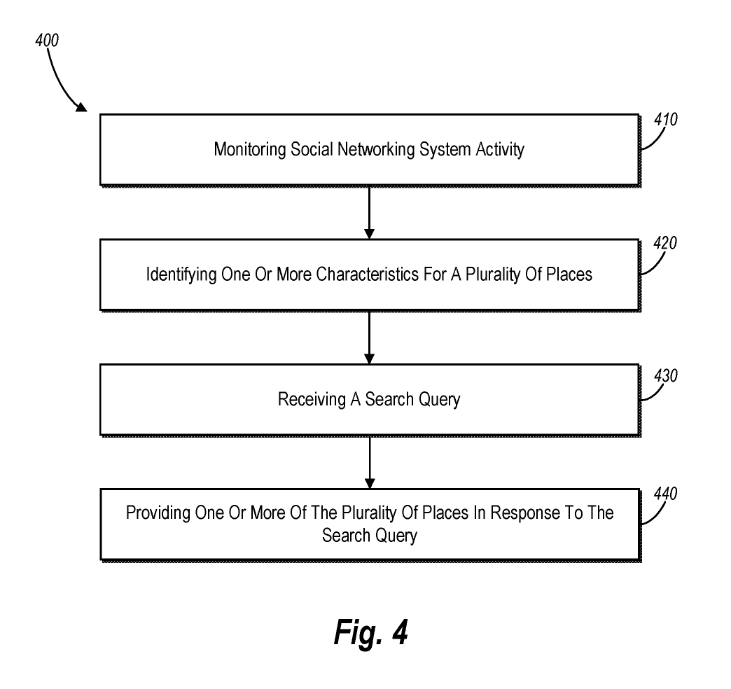

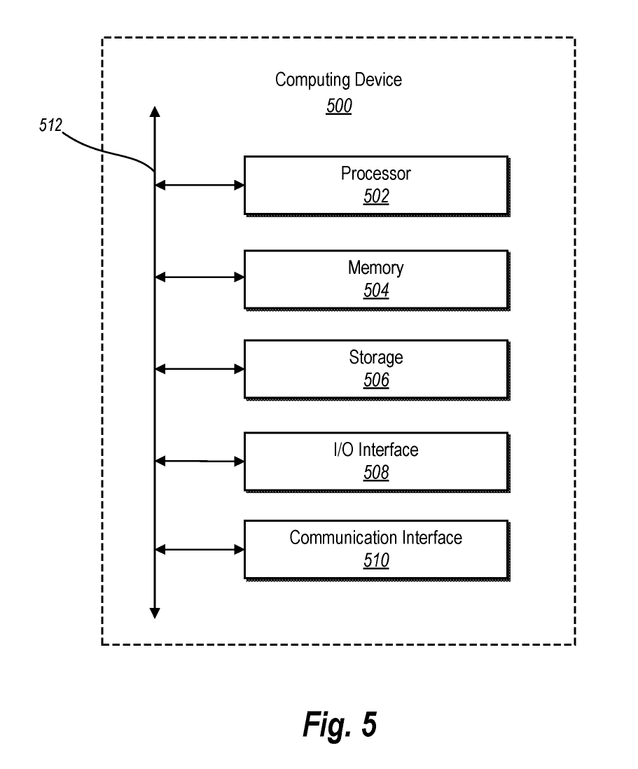

FIGS. 1-3E, the corresponding text, and the examples, provide a number of different methods, systems, and devices for inferring qualities and characteristics of places based on social networking system information with the search manager 106. In addition to the foregoing, embodiments can also be described in terms of flowcharts comprising acts and steps in a method for accomplishing a particular result. For example, FIG. 4 may be performed with less or more steps/acts or the steps/acts may be performed in differing orders. Additionally, the steps/acts described herein may be repeated or performed in parallel with one another or in parallel with different instances of the same or similar steps/acts.

FIG. 4 illustrates a flowchart of one example method 400 of inferring qualities of a place via a social networking system. The method 400 includes an act 410 of monitoring social networking system activity. In particular, the act 410 can involve monitoring social networking system activity (e.g., posts, check-in posts, etc.) for social networking system activity specific to a plurality of places (e.g., restaurants, parks, tourist attractions, etc.). For example, in one or more embodiments, monitoring social networking system activity for social networking system activity specific to a plurality of places includes monitoring social networking system activity for check-in posts.

The method 400 also includes an act 420 of identifying one or more characteristics for each of the plurality of places. In particular, the act 420 can involve identifying, from the monitored social networking system activity, one or more characteristics for each of the plurality of places. For example, in one or more embodiments, identifying one or more characteristics for each of the plurality of places includes determining a number of check-ins associated with each of the plurality of places. Additionally or alternatively, identifying one or more characteristics for each of the plurality of places includes identifying attributes of one or more posters of each of one or more check-in posts. Furthermore, identifying one or more characteristics for each of the plurality of places can include analyzing data associated with the monitored social networking system activity.

In at least one embodiment, analyzing data associated with the monitored social networking system activity includes identifying one or more check-in posts within the monitored social networking system activity. Then, for each identified check-in post, analyzing data includes performing text analysis on text associated with the check-in post, performing image analysis in connection with digital media associated with the check-in post, and analyzing one or more attributes of social networking system users tagged in the check-in post.

The method 400 also includes an act 430 of receiving a search query. In particular, the act 430 can involve receiving, from a social networking system user, a search query via the social networking system. In one or more embodiments, receiving, from the social networking system user, the search query via the social networking system includes providing a multi-step query tool to the social networking system user via the social networking system (see e.g., FIGS. 3B-3E), and generating the search query based on the social networking system user's response to the multi-step query tool. In at least one embodiment, the method 400 further includes generating the multi-step query tool, wherein generating the multi-step query tool is based on social networking system activity specific to the social networking system user.

The method 400 further includes an act 440 of providing one or more of the plurality of places in response to the search query. In particular, the act 440 can involve providing, based on the identified one or more characteristics for each of the plurality of places and social networking system activity specific to the social networking system user, one or more of the plurality of places in response to the search query. For example, providing one or more of the plurality of places in response to the search query can include searching one or more repositories of characteristics associated with the plurality of places for one or more places associated with qualities related to the received search query.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 5 illustrates a block diagram of exemplary computing device 500 that may be configured to perform one or more of the processes described above. One will appreciate that one or more computing devices such as the computing device 500 may implement the system 100. As shown by FIG. 5, the computing device 500 can comprise a processor 502, a memory 504, a storage device 506, an I/O interface 508, and a communication interface 510, which may be communicatively coupled by way of a communication infrastructure 512. While an exemplary computing device 500 is shown in FIG. 5, the components illustrated in FIG. 5 are not intended to be limiting. Additional or alternative components may be used in other embodiments. Furthermore, in certain embodiments, the computing device 500 can include fewer components than those shown in FIG. 5. Components of the computing device 500 shown in FIG. 5 will now be described in additional detail.

In one or more embodiments, the processor 502 includes hardware for executing instructions, such as those making up a computer program. As an example and not by way of limitation, to execute instructions, the processor 502 may retrieve (or fetch) the instructions from an internal register, an internal cache, the memory 504, or the storage device 506 and decode and execute them. In one or more embodiments, the processor 502 may include one or more internal caches for data, instructions, or addresses. As an example and not by way of limitation, the processor 502 may include one or more instruction caches, one or more data caches, and one or more translation lookaside buffers (TLBs). Instructions in the instruction caches may be copies of instructions in the memory 504 or the storage 506.

The memory 504 may be used for storing data, metadata, and programs for execution by the processor(s). The memory 504 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 504 may be internal or distributed memory.

The storage device 506 includes storage for storing data or instructions. As an example and not by way of limitation, storage device 506 can comprise a non-transitory storage medium described above. The storage device 506 may include a hard disk drive (HDD), a floppy disk drive, flash memory, an optical disc, a magneto-optical disc, magnetic tape, or a Universal Serial Bus (USB) drive or a combination of two or more of these. The storage device 506 may include removable or non-removable (or fixed) media, where appropriate. The storage device 506 may be internal or external to the computing device 500. In one or more embodiments, the storage device 506 is non-volatile, solid-state memory. In other embodiments, the storage device 506 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 508 allows a user to provide input to, receive output from, and otherwise transfer data to and receive data from computing device 500. The I/O interface 508 may include a mouse, a keypad or a keyboard, a touch screen, a camera, an optical scanner, network interface, modem, other known I/O devices or a combination of such I/O interfaces. The I/O interface 508 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 508 is configured to provide graphical data to a display for presentation to a user. The graphical data may be representative of one or more graphical user interfaces and/or any other graphical content as may serve a particular implementation.

The communication interface 510 can include hardware, software, or both. In any event, the communication interface 510 can provide one or more interfaces for communication (such as, for example, packet-based communication) between the computing device 500 and one or more other computing devices or networks. As an example and not by way of limitation, the communication interface 510 may include a network interface controller (NIC) or network adapter for communicating with an Ethernet or other wire-based network or a wireless NIC (WNIC) or wireless adapter for communicating with a wireless network, such as a WI-FI.

Additionally or alternatively, the communication interface 510 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 510 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 510 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 512 may include hardware, software, or both that couples components of the computing device 500 to each other. As an example and not by way of limitation, the communication infrastructure 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, the system 100 can comprise a social networking system. A social networking system may enable its users (such as persons or organizations) to interact with the system and with each other. The social networking system may, with input from a user, create and store in the social networking system a user profile associated with the user. The user profile may include demographic information, communication-channel information, and information on personal interests of the user. The social networking system may also, with input from a user, create and store a record of relationships of the user with other users of the social networking system, as well as provide services (e.g., posts, photo-sharing, video-sharing, event organization, messaging, games, or advertisements) to facilitate social interaction between or among users.

The social networking system may store records of users and relationships between users in a social graph comprising a plurality of nodes and a plurality of edges connecting the nodes. The nodes may comprise a plurality of user nodes and a plurality of concept nodes. A user node of the social graph may correspond to a user of the social networking system. A user may be an individual (human user), an entity (e.g., an enterprise, business, or third party application), or a group (e.g., of individuals or entities). A user node corresponding to a user may comprise information provided by the user and information gathered by various systems, including the social networking system.

For example, the user may provide his or her name, profile picture, city of residence, contact information, birth date, gender, marital status, family status, employment, educational background, preferences, interests, and other demographic information to be included in the user node. Each user node of the social graph may have a corresponding web page (typically known as a profile page). In response to a request including a user name, the social networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

A concept node may correspond to a concept of the social networking system. For example, a concept can represent a real-world entity, such as a movie, a song, a sports team, a celebrity, a group, a restaurant, or a place or a location. An administrative user of a concept node corresponding to a concept may create or update the concept node by providing information of the concept (e.g., by filling out an online form), causing the social networking system to associate the information with the concept node. For example and without limitation, information associated with a concept can include a name or a title, one or more images (e.g., an image of cover page of a book), a web site (e.g., an URL address) or contact information (e.g., a phone number, an email address). Each concept node of the social graph may correspond to a web page. For example, in response to a request including a name, the social networking system can access a concept node corresponding to the name, and construct a web page including the name and other information associated with the concept.

An edge between a pair of nodes may represent a relationship between the pair of nodes. For example, an edge between two user nodes can represent a friendship between two users. For another example, the social networking system may construct a web page (or a structured document) of a concept node (e.g., a restaurant, a celebrity), incorporating one or more selectable option or selectable elements (e.g., “like”, “check in”) in the web page. A user can access the page using a web browser hosted by the user's client device and select a selectable option or selectable element, causing the client device to transmit to the social networking system a request to create an edge between a user node of the user and a concept node of the concept, indicating a relationship between the user and the concept (e.g., the user checks in a restaurant, or the user “likes” a celebrity).

As an example, a user may provide (or change) his or her city of residence, causing the social networking system to create an edge between a user node corresponding to the user and a concept node corresponding to the city declared by the user as his or her city of residence. In addition, the degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.”

A social networking system may support a variety of applications, such as photo sharing, on-line calendars and events, gaming, instant messaging, and advertising. For example, the social networking system may also include media sharing capabilities. Also, the social networking system may allow users to post photographs and other multimedia content items to a user's profile page (typically known as “wall posts” or “timeline posts”) or in a photo album, both of which may be accessible to other users of the social networking system depending upon the user's configured privacy settings. The social networking system may also allow users to configure events. For example, a first user may configure an event with attributes including time and date of the event, location of the event and other users invited to the event. The invited users may receive invitations to the event and respond (such as by accepting the invitation or declining it). Furthermore, the social networking system may allow users to maintain a personal calendar. Similarly to events, the calendar entries may include times, dates, locations and identities of other users.

FIG. 6 illustrates an example network environment 600 of a social networking system. Network environment 600 includes a client system 606, a social networking system 602, and a third-party system 608 connected to each other by a network 604. Although FIG. 6 illustrates a particular arrangement of client system 606, social networking system 602, third-party system 608, and network 604, this disclosure contemplates any suitable arrangement of client system 606, social networking system 602, third-party system 608, and network 604. As an example and not by way of limitation, two or more of client system 606, social networking system 602, and third-party system 608 may be connected to each other directly, bypassing network 604. As another example, two or more of client system 606, social networking system 602, and third-party system 608 may be physically or logically co-located with each other in whole or in part. Moreover, although FIG. 6 illustrates a particular number of client systems 606, social networking systems 602, third-party systems 608, and networks 604, this disclosure contemplates any suitable number of client systems 606, social networking systems 602, third-party systems 608, and networks 604. As an example and not by way of limitation, network environment 600 may include multiple client system 606, social networking systems 602, third-party systems 608, and networks 604.

This disclosure contemplates any suitable network 604. As an example and not by way of limitation, one or more portions of network 604 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 604 may include one or more networks 604.

Links may connect client system 606, social networking system 602, and third-party system 608 to communication network 604 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 600. One or more first links may differ in one or more respects from one or more second links.

In particular embodiments, client system 606 may be an electronic device including hardware, software, or embedded logic components or a combination of two or more such components and capable of carrying out the appropriate functionalities implemented or supported by client system 606. As an example and not by way of limitation, a client system 606 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 606. A client system 606 may enable a network user at client system 606 to access network 604. A client system 606 may enable its user to communicate with other users at other client systems 606.

In particular embodiments, client system 606 may include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 606 may enter a Uniform Resource Locator (URL) or other address directing the web browser to a particular server (such as server, or a server associated with a third-party system 608), and the web browser may generate a Hyper Text Transfer Protocol (HTTP) request and communicate the HTTP request to server. The server may accept the HTTP request and communicate to client system 606 one or more Hyper Text Markup Language (HTML) files responsive to the HTTP request. Client system 606 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social networking system 602 may be a network-addressable computing system that can host an online social network. Social networking system 602 may generate, store, receive, and send social-networking data, such as, for example, user-profile data, concept-profile data, social-graph information, or other suitable data related to the online social network. Social networking system 602 may be accessed by the other components of network environment 600 either directly or via network 604. In particular embodiments, social networking system 602 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, social networking system 602 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client system 606, a social networking system 602, or a third-party system 608 to manage, retrieve, modify, add, or delete, the information stored in data store.

In particular embodiments, social networking system 602 may store one or more social graphs in one or more data stores. In particular embodiments, a social graph may include multiple nodes—which may include multiple user nodes (each corresponding to a particular user) or multiple concept nodes (each corresponding to a particular concept)—and multiple edges connecting the nodes. Social networking system 602 may provide users of the online social network the ability to communicate and interact with other users. In particular embodiments, users may join the online social network via social networking system 602 and then add connections (e.g., relationships) to a number of other users of social networking system 602 whom they want to be connected to. Herein, the term “friend” may refer to any other user of social networking system 602 with whom a user has formed a connection, association, or relationship via social networking system 602.

In particular embodiments, social networking system 602 may provide users with the ability to take actions on various types of items or objects, supported by social networking system 602. As an example and not by way of limitation, the items and objects may include groups or social networks to which users of social networking system 602 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social networking system 602 or by an external system of third-party system 608, which is separate from social networking system 602 and coupled to social networking system 602 via a network 604.

In particular embodiments, social networking system 602 may be capable of linking a variety of entities. As an example and not by way of limitation, social networking system 602 may enable users to interact with each other as well as receive content from third-party systems 608 or other entities, or to allow users to interact with these entities through an application programming interfaces (API) or other communication channels.

In particular embodiments, a third-party system 608 may include one or more types of servers, one or more data stores, one or more interfaces, including but not limited to APIs, one or more web services, one or more content sources, one or more networks, or any other suitable components, e.g., that servers may communicate with. A third-party system 608 may be operated by a different entity from an entity operating social networking system 602. In particular embodiments, however, social networking system 602 and third-party systems 608 may operate in conjunction with each other to provide social-networking services to users of social networking system 602 or third-party systems 608. In this sense, social networking system 602 may provide a platform, or backbone, which other systems, such as third-party systems 608, may use to provide social-networking services and functionality to users across the Internet.

In particular embodiments, a third-party system 608 may include a third-party content object provider. A third-party content object provider may include one or more sources of content objects, which may be communicated to a client system 606. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social networking system 602 also includes user-generated content objects, which may enhance a user's interactions with social networking system 602. User-generated content may include anything a user can add, upload, send, or “post” to social networking system 602. As an example and not by way of limitation, a user communicates posts to social networking system 602 from a client system 606. Posts may include data such as status updates or other textual data, location information, photos, videos, links, music or other similar data or media. Content may also be added to social networking system 602 by a third-party through a “communication channel,” such as a newsfeed or stream.

In particular embodiments, social networking system 602 may include a variety of servers, sub-systems, programs, modules, logs, and data stores. In particular embodiments, social networking system 602 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social networking system 602 may also include suitable components such as network interfaces, security mechanisms, load balancers, failover servers, management-and-network-operations consoles, other suitable components, or any suitable combination thereof. In particular embodiments, social networking system 602 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social networking system 602 to one or more client systems 606 or one or more third-party system 608 via network 604. The web server may include a mail server or other messaging functionality for receiving and routing messages between social networking system 602 and one or more client systems 606. An API-request server may allow a third-party system 608 to access information from social networking system 602 by calling one or more APIs. An action logger may be used to receive communications from a web server about a user's actions on or off social networking system 602. In conjunction with the action log, a third-party-content-object log may be maintained of user exposures to third-party-content objects. A notification controller may provide information regarding content objects to a client system 606. Information may be pushed to a client system 606 as notifications, or information may be pulled from client system 606 responsive to a request received from client system 606. Authorization servers may be used to enforce one or more privacy settings of the users of social networking system 602. A privacy setting of a user determines how particular information associated with a user can be shared. The authorization server may allow users to opt in to or opt out of having their actions logged by social networking system 602 or shared with other systems (e.g., third-party system 608), such as, for example, by setting appropriate privacy settings. Third-party-content-object stores may be used to store content objects received from third parties, such as a third-party system 608. Location stores may be used for storing location information received from client systems 606 associated with users. Advertisement-pricing modules may combine social information, the current time, location information, or other suitable information to provide relevant advertisements, in the form of notifications, to a user.

FIG. 7 illustrates example social graph 700. In particular embodiments, social networking system 602 may store one or more social graphs 700 in one or more data stores. In particular embodiments, social graph 700 may include multiple nodes—which may include multiple user nodes 702 or multiple concept nodes 704—and multiple edges 706 connecting the nodes. Example social graph 700 illustrated in FIG. 7 is shown, for didactic purposes, in a two-dimensional visual map representation. In particular embodiments, a social networking system 602, client system 606, or third-party system 608 may access social graph 700 and related social-graph information for suitable applications. The nodes and edges of social graph 700 may be stored as data objects, for example, in a data store (such as a social-graph database). Such a data store may include one or more searchable or query able indexes of nodes or edges of social graph 700.

In particular embodiments, a user node 702 may correspond to a user of social networking system 602. As an example and not by way of limitation, a user may be an individual (human user), an entity (e.g., an enterprise, business, or third-party application), or a group (e.g., of individuals or entities) that interacts or communicates with or over social networking system 602. In particular embodiments, when a user registers for an account with social networking system 602, social networking system 602 may create a user node 702 corresponding to the user, and store the user node 702 in one or more data stores. Users and user nodes 702 described herein may, where appropriate, refer to registered users and user nodes 702 associated with registered users. In addition or as an alternative, users and user nodes 702 described herein may, where appropriate, refer to users that have not registered with social networking system 602. In particular embodiments, a user node 702 may be associated with information provided by a user or information gathered by various systems, including social networking system 602. As an example and not by way of limitation, a user may provide his or her name, profile picture, contact information, birth date, sex, marital status, family status, employment, education background, preferences, interests, or other demographic information. In particular embodiments, a user node 702 may be associated with one or more data objects corresponding to information associated with a user. In particular embodiments, a user node 702 may correspond to one or more webpages.

In particular embodiments, a concept node 704 may correspond to a concept. As an example and not by way of limitation, a concept may correspond to a place (such as, for example, a movie theater, restaurant, landmark, or city); a website (such as, for example, a website associated with social-network system 602 or a third-party website associated with a web-application server); an entity (such as, for example, a person, business, group, sports team, or celebrity); a resource (such as, for example, an audio file, video file, digital photo, text file, structured document, or application) which may be located within social networking system 602 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 704 may be associated with information of a concept provided by a user or information gathered by various systems, including social networking system 602. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 704 may be associated with one or more data objects corresponding to information associated with concept node 704. In particular embodiments, a concept node 704 may correspond to one or more webpages.

In particular embodiments, a node in social graph 700 may represent or be represented by a webpage (which may be referred to as a “profile page”). Profile pages may be hosted by or accessible to social networking system 602. Profile pages may also be hosted on third-party websites associated with a third-party server 708. As an example and not by way of limitation, a profile page corresponding to a particular external webpage may be the particular external webpage and the profile page may correspond to a particular concept node 704. Profile pages may be viewable by all or a selected subset of other users. As an example and not by way of limitation, a user node 702 may have a corresponding user-profile page in which the corresponding user may add content, make declarations, or otherwise express himself or herself. As another example and not by way of limitation, a concept node 704 may have a corresponding concept-profile page in which one or more users may add content, make declarations, or express themselves, particularly in relation to the concept corresponding to concept node 704.

In particular embodiments, a concept node 704 may represent a third-party webpage or resource hosted by a third-party system 608. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system 606 to send to social networking system 602 a message indicating the user's action. In response to the message, social networking system 602 may create an edge (e.g., an “eat” edge) between a user node 702 corresponding to the user and a concept node 704 corresponding to the third-party webpage or resource and store edge 706 in one or more data stores.

In particular embodiments, a pair of nodes in social graph 700 may be connected to each other by one or more edges 706. An edge 706 connecting a pair of nodes may represent a relationship between the pair of nodes. In particular embodiments, an edge 706 may include or represent one or more data objects or attributes corresponding to the relationship between a pair of nodes. As an example and not by way of limitation, a first user may indicate that a second user is a “friend” of the first user. In response to this indication, social networking system 602 may send a “friend request” to the second user. If the second user confirms the “friend request,” social networking system 602 may create an edge 706 connecting the first user's user node 702 to the second user's user node 702 in social graph 700 and store edge 706 as social-graph information in one or more of data stores. In the example of FIG. 7, social graph 700 includes an edge 706 indicating a friend relation between user nodes 702 of user “A” and user “B” and an edge indicating a friend relation between user nodes 702 of user “C” and user “B.” Although this disclosure describes or illustrates particular edges 706 with particular attributes connecting particular user nodes 702, this disclosure contemplates any suitable edges 706 with any suitable attributes connecting user nodes 702. As an example and not by way of limitation, an edge 706 may represent a friendship, family relationship, business or employment relationship, fan relationship, follower relationship, visitor relationship, sub scriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 700 by one or more edges 706.

In particular embodiments, an edge 706 between a user node 702 and a concept node 704 may represent a particular action or activity performed by a user associated with user node 702 toward a concept associated with a concept node 704. As an example and not by way of limitation, as illustrated in FIG. 7, a user may “like,” “attended,” “played,” “listened,” “cooked,” “worked at,” or “watched” a concept, each of which may correspond to a edge type or subtype. A concept-profile page corresponding to a concept node 704 may include, for example, a selectable “check in” icon (such as, for example, a clickable “check in” icon) or a selectable “add to favorites” icon. Similarly, after a user clicks these icons, social networking system 602 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social networking system 602 may create a “listened” edge 706 and a “used” edge (as illustrated in FIG. 7) between user nodes 702 corresponding to the user and concept nodes 704 corresponding to the song and application to indicate that the user listened to the song and used the application. Moreover, social networking system 602 may create a “played” edge 706 (as illustrated in FIG. 7) between concept nodes 704 corresponding to the song and the application to indicate that the particular song was played by the particular application. In this case, “played” edge 706 corresponds to an action performed by an external application (SPOTIFY) on an external audio file (the song “Imagine”). Although this disclosure describes particular edges 706 with particular attributes connecting user nodes 702 and concept nodes 704, this disclosure contemplates any suitable edges 706 with any suitable attributes connecting user nodes 702 and concept nodes 704. Moreover, although this disclosure describes edges between a user node 702 and a concept node 704 representing a single relationship, this disclosure contemplates edges between a user node 702 and a concept node 704 representing one or more relationships. As an example and not by way of limitation, an edge 706 may represent both that a user likes and has used at a particular concept. Alternatively, another edge 706 may represent each type of relationship (or multiples of a single relationship) between a user node 702 and a concept node 704 (as illustrated in FIG. 7 between user node 702 for user “E” and concept node 704 for “SPOTIFY”).

In particular embodiments, social networking system 602 may create an edge 706 between a user node 702 and a concept node 704 in social graph 700. As an example and not by way of limitation, a user viewing a concept-profile page (such as, for example, by using a web browser or a special-purpose application hosted by the user's client system 606) may indicate that he or she likes the concept represented by the concept node 704 by clicking or selecting a “Like” icon, which may cause the user's client system 606 to send to social networking system 602 a message indicating the user's liking of the concept associated with the concept-profile page. In response to the message, social networking system 602 may create an edge 706 between user node 702 associated with the user and concept node 704, as illustrated by “like” edge 706 between the user and concept node 704. In particular embodiments, social networking system 602 may store an edge 706 in one or more data stores. In particular embodiments, an edge 706 may be automatically formed by social networking system 602 in response to a particular user action. As an example and not by way of limitation, if a first user uploads a picture, watches a movie, or listens to a song, an edge 706 may be formed between user node 702 corresponding to the first user and concept nodes 704 corresponding to those concepts. Although this disclosure describes forming particular edges 706 in particular manners, this disclosure contemplates forming any suitable edges 706 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a newsfeed or ticker item on social networking system 602). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within newsfeeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social networking system 602 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social networking system 602) or RSVP (e.g., through social networking system 602) to an event associated with the advertisement. In addition or as an alternative, an advertisement may include social-networking-system context directed to the user. As an example and not by way of limitation, an advertisement may display information about a friend of the user within social networking system 602 who has taken an action associated with the subject matter of the advertisement.

In particular embodiments, social networking system 602 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 708 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social networking system 602 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part the history of the user's actions. Coefficients may be used to predict any number of actions, which may be within or outside of the online social network. As an example and not by way of limitation, these actions may include various types of communications, such as sending messages, posting content, or commenting on content; various types of a observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social networking system 602 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social networking system 602 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social networking system 602 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social networking system 602 may calculate a coefficient based on a user's actions. Social networking system 602 may monitor such actions on the online social network, on a third-party system 608, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, social networking system 602 may calculate a coefficient based on the user's actions with particular types of content. The content may be associated with the online social network, a third-party system 608, or another suitable system. The content may include users, profile pages, posts, news stories, headlines, instant messages, chat room conversations, emails, advertisements, pictures, video, music, other suitable objects, or any combination thereof. Social networking system 602 may analyze a user's actions to determine whether one or more of the actions indicate an affinity for subject matter, content, other users, and so forth. As an example and not by way of limitation, if a user may make frequently posts content related to “coffee” or variants thereof, social networking system 602 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social networking system 602 may calculate a coefficient based on the type of relationship between particular objects. Referencing the social graph 700, social networking system 602 may analyze the number and/or type of edges 706 connecting particular user nodes 702 and concept nodes 704 when calculating a coefficient. As an example and not by way of limitation, user nodes 702 that are connected by a spouse-type edge (representing that the two users are married) may be assigned a higher coefficient than a user node 702 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, social networking system 602 may determine that the user has a higher coefficient with respect to the first photo than the second photo because having a tagged-in-type relationship with content may be assigned a higher weight and/or rating than having a like-type relationship with content. In particular embodiments, social networking system 602 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social networking system 602 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 700. As an example and not by way of limitation, social-graph entities that are closer in the social graph 700 (i.e., fewer degrees of separation) may have a higher coefficient than entities that are further apart in the social graph 700.

In particular embodiments, social networking system 602 may calculate a coefficient based on location information. Objects that are geographically closer to each other may be considered to be more related, or of more interest, to each other than more distant objects. In particular embodiments, the coefficient of a user towards a particular object may be based on the proximity of the object's location to a current location associated with the user (or the location of a client system 606 of the user). A first user may be more interested in other users or concepts that are closer to the first user. As an example and not by way of limitation, if a user is one mile from an airport and two miles from a gas station, social networking system 602 may determine that the user has a higher coefficient for the airport than the gas station based on the proximity of the airport to the user.

In particular embodiments, social networking system 602 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social networking system 602 may provide information that is relevant to user's interests and current circumstances, increasing the likelihood that they will find such information of interest. In particular embodiments, social networking system 602 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social networking system 602 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social networking system 602 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 608 (e.g., via an API or other communication channel), or from another suitable system. In response to the request, social networking system 602 may calculate the coefficient (or access the coefficient information if it has previously been calculated and stored). In particular embodiments, social networking system 602 may measure an affinity with respect to a particular process. Different processes (both internal and external to the online social network) may request a coefficient for a particular object or set of objects. Social networking system 602 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, field 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 704 corresponding to a particular photo may have a privacy setting specifying that the photo may only be accessed by users tagged in the photo and their friends. In particular embodiments, privacy settings may allow users to opt in or opt out of having their actions logged by social networking system 602 or shared with other systems (e.g., third-party system 608). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 608, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, social networking system 602 may send a request to the data store for the object. The request may identify the user associated with the request and may only be sent to the user (or a client system 606 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A method comprising:
monitoring social networking system activity for social networking system activity specific to a plurality of places;
identifying, from the monitored social networking system activity, one or more characteristics for each of the plurality of places;
receiving, from a social networking system user, a search query via the social networking system; and
providing, based on the identified one or more characteristics for each of the plurality of places and social networking system activity specific to the social networking system user, one or more of the plurality of places in response to the search query.

2. The method as recited in claim 1, wherein monitoring social networking system activity for social networking system activity specific to a plurality of places comprises monitoring social networking system activity for check-in posts.

3. The method as recited in claim 1, wherein identifying one or more characteristics for each of the plurality of places comprises determining a number of check-ins associated with each of the plurality of places.

4. The method as recited in claim 1, wherein identifying one or more characteristics for each of the plurality of places comprises identifying attributes of one or more posters of each of one or more check-in posts.

5. The method as recited in claim 1, wherein identifying one or more characteristics for each of the plurality of places comprises analyzing data associated with the monitored social networking system activity.

6. The method as recited in claim 5, wherein analyzing data associated with the monitored social networking system activity comprises:
identifying one or more check-in posts within the monitored social networking system activity;
for each identified check-in post:
performing text analysis on text associated with the check-in post;
performing image analysis in connection with digital media associated with the check-in post;
analyzing one or more attributes of social networking system users tagged in the check-in post.

7. The method as recited in claim 1, wherein receiving, from the social networking system user, the search query via the social networking system comprises:
providing a multi-step query tool to the social networking system user via the social networking system;
generating the search query based on the social networking system user's response to the multi-step query tool.

8. The method as recited in claim 7, further comprising generating the multi-step query tool, wherein generating the multi-step query tool is based on social networking system activity specific to the social networking system user.

9. A system comprising:
at least one processor; and
at least one non-transitory computer-readable storage medium storing instructions thereon that, when executed by the at least one processor, cause the system to:
monitor social networking system activity for social networking system activity specific to a plurality of places;
identify, from the monitored social networking system activity, one or more characteristics for each of the plurality of places;
receive, from a social networking system user, a search query via the social networking system; and
provide, based on the identified one or more characteristics for each of the plurality of places and social networking system activity specific to the social networking system user, one or more of the plurality of places in response to the search query.

10. The system as recited in claim 9, wherein monitoring social networking system activity for social networking system activity specific to a plurality of places comprises monitoring social networking system activity for check-in posts.

11. The system as recited in claim 10, wherein identifying one or more characteristics for each of the plurality of places comprises determining a number of check-ins associated with each of the plurality of places.

12. The system as recited in claim 11, wherein identifying one or more characteristics for each of the plurality of places further comprises identifying attributes of one or more posters of each of one or more check-in posts.

13. The system as recited in claim 12, wherein identifying one or more characteristics for each of the plurality of places further comprises analyzing data associated with the monitored social networking system activity.

14. The system as recited in claim 13, wherein analyzing data associated with the monitored social networking system activity comprises:
identifying one or more check-in posts within the monitored social networking system activity;
for each identified check-in post:
performing text analysis on text associated with the check-in post;
performing image analysis in connection with digital media associated with the check-in post;
analyzing one or more attributes of social networking system users tagged in the check-in post.

15. The system as recited in claim 14, wherein receiving, from the social networking system user, the search query via the social networking system comprises:
providing a multi-step query tool to the social networking system user via the social networking system;
generating the search query based on the social networking system user's response to the multi-step query tool.

16. The system as recited in claim 15, further comprising instructions that, when executed by the at least one processor, cause the system to generate the multi-step query tool, wherein generating the multi-step query tool is based on social networking system activity specific to the social networking system user.

17. A non-transitory computer readable medium storing instructions thereon that, when executed by at least one processor, cause a computer system to:
monitor social networking system activity for social networking system activity specific to a plurality of places;
identify, from the monitored social networking system activity, one or more characteristics for each of the plurality of places;
receive, from a social networking system user, a search query via the social networking system; and
provide, based on the identified one or more characteristics for each of the plurality of places and social networking system activity specific to the social networking system user, one or more of the plurality of places in response to the search query.

18. The non-transitory computer readable medium as recited in claim 17, wherein monitoring social networking system activity for social networking system activity specific to a plurality of places comprises monitoring social networking system activity for check-in posts.

19. The non-transitory computer readable medium as recited in claim 18, wherein identifying one or more characteristics for each of the plurality of places comprises identifying attributes of one or more posters of each of one or more check-in posts, and analyzing data associated with the monitored social networking system activity.

20. The non-transitory computer readable medium as recited in claim 19, wherein analyzing data associated with the monitored social networking system activity comprises:
identifying one or more check-in posts within the monitored social networking system activity;
for each identified check-in post:
performing text analysis on text associated with the check-in post;
performing image analysis in connection with digital media associated with the check-in post;
analyzing one or more attributes of social networking system users tagged in the check-in post.
